(19) United States
(12) Patent Application Publication
(10) Pub. No.: US 2017/0038872 A1
(43) Pub. Date: Feb. 9, 2017

(54) TOUCH SCREEN AND PREPARATION METHOD THEREOF

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Qinghua JIANG, Beijing (CN); Honggang GU, Beijing (CN); Xianjie SHAO, Beijing (CN)

(73) Assignees: BOE TECHNOLOGY GROUP CO., LTD., Beijing (CN); HEFEI BOE OPTOELECTRONICS TECHNOLOGY CO., LTD., Hefei, Anhui (CN)

(21) Appl. No.: 14/908,713

(22) PCT Filed: Jul. 16, 2015
(86) PCT No.: PCT/CN2015/084213

§ 371 Date: Jan. 29, 2016

(30) Foreign Application Priority Data
Mar. 31, 2015 (CN) 201510150447.1

(51) Int. Cl. G06F 3/041; G02F 1/1343; G02F 1/1335; G02F 1/1333

(52) U.S. Cl. CPC G06F 3/0412; G02F 1/13338; G02F 1/134309; G02F 1/13439; G02F 1/133528; G06F 2203/04103; G02F 2001/133331

(57) ABSTRACT

The present invention discloses a touch screen and a preparation method thereof. The touch screen comprises a display panel, an electrode layer, and a filling structure; the electrode layer is located on a light emitting side of the display panel and comprises a plurality of touch electrodes with spacing provided between the touch electrodes; and the filling structure is located in the spacing and has a preset refractive index. In the present invention, a refractive index of the electrode layer is equal to or approximate to that of the filling structure located in the spacing, the difference between the refractive index of the electrode layer and the refractive index of the filling structure is reduced, and the difference between the light transmittance of the electrode layer and the light transmittance of the filling structure is reduced, thereby avoiding poor vanishing phenomenon.

### FIELD OF THE INVENTION

The present invention relates to the field of display technology, and in particular to a touch screen and a preparation method thereof.

### BACKGROUND OF THE INVENTION

With the development of display technology, touch screens are applied more and more widely. An on cell touch screen, as an important type of the touch screen, is formed by embedding a touch structure between a color film substrate and a polarizer of a display device, namely, providing a touch sensor on a display panel. FIG. 1 is a schematic structure diagram of a touch screen in the prior art. As shown in FIG. 1, the touch screen includes a display panel 1, an electrode layer 2, a connection layer 5, a polarizer 6 and a cover glass 4. The electrode layer 2 includes a plurality of touch electrodes 21 with spacing 22 provided between the respective touch electrodes 21, and the electrode layer 2 is located on a light emitting side of the display panel 1; the connection layer 5 is located on the electrode layer 2, the polarizer 6 is located on the connection layer 5, and the cover glass 4 is located on the polarizer 6, wherein the connection layer 5 may be made of pressure sensitive adhesive (abbreviated as PSA), and the connection layer 5 may bond the electrode layer 2 and the polarizer 6, and the electrode layer 2 is made of indium tin oxide (abbreviated as ITO), wherein the electrode layer 2 is a single-layer electrode layer, i.e., a plurality of touch electrodes 21 are manufactured by using the single-layer electrode layer and the plurality of touch electrodes 21 may include drive electrodes (Tx) and sensing electrodes (Rx), for example: the drive electrodes may be arranged transversally, and the sensing electrodes may be arranged longitudinally. A drive electrode and a sensing electrode form two electrodes of a capacitor respectively. When a human finger touches the touch screen, the coupling between the two electrodes near the touch point is influenced, thereby changing the capacitance between the two electrodes. When mutual capacitances are detected, the transverse drive electrodes send out drive signals in turn, all the sensing electrodes in the longitudinal direction receive sensed signals at the same time, so that the capacitances at the junctions of all the transverse drive electrodes and the longitudinal sensing electrodes may be obtained, which are the capacitances of the two-dimensional plane of the whole touch screen. When the human finger touches the touch screen, partial capacitances of the two-dimensional plane of the touch screen may be reduced. Therefore, coordinate of each touch point may be calculated according to capacitance changes of the two-dimensional plane of the touch screen. In this way, even if there is a plurality of touch points on the touch screen, the real coordinate of each touch point can be calculated.

However, when the electrode layer 2 is made of ITO, a refractive index of the electrode layer 2 is 1.5, and the touch electrodes 21 are spaced by air which has a refractive index of 1. As the difference between the refractive index of the electrode layer 2 and the refractive index of the spacing without the electrode layer 2 is relatively large, the difference between the light transmittance of the electrode layer 2 and the light transmittance of the spacing without the electrode layer 2 is relatively large, resulting in poor vanishing phenomenon.

### SUMMARY OF THE INVENTION

The present invention provides a touch screen and a preparation method thereof, for avoiding poor vanishing phenomenon in the prior art.

In order to achieve the aforementioned objective, a touch screen is provided in the present invention, including: a display panel, an electrode layer, and a filling structure, the electrode layer being located on a light emitting side of the display panel and including a plurality of touch electrodes with spacing provided between the respective touch electrodes, and the filling structure being located in the spacing and having a preset refractive index.

Optionally, the touch screen further includes a cover glass arranged on the electrode layer.

Optionally, the touch screen further includes a connection layer located on the electrode layer.

Optionally, the connection layer and the filling structure are integrally molded.

Optionally, a ratio of the difference between the preset refractive index of the filling structure and a refractive index of the electrode layer to the refractive index of the electrode layer is within a range of −20% to 20%.

Optionally, the preset refractive index of the filling structure is larger than or equal to 1.2 and less than or equal to 1.8.

Optionally, a ratio of the difference between a preset light transmittance of the filling structure and a light transmittance of the electrode layer to the light transmittance of the electrode layer is within a range of −5% to 5%.

Optionally, the filling structure is made of apparent resin liquid glue.

In order to achieve the aforementioned objective, a preparation method of a touch screen is provided in the present invention, including:

preparing a display panel;

forming an electrode layer on a light emitting side of the display panel, the electrode layer including a plurality of touch electrodes with spacing provided between the touch electrodes; and

forming a filling structure in the spacing, the filling structure having a preset refractive index.

Optionally, the preparation method of a touch screen further includes: forming a connection layer located on the electrode layer.

Optionally, the connection layer and the filling structure are integrally molded, for example, a material layer may be formed on the electrode layer, a part of the material layer being filled in the spacing for forming the filling structure, and the material layer located on the electrode layer and the filling structure being used for forming the connection layer.

Optionally, the preparation method of a touch screen further includes: curing the material layer to form the filling structure and the connection layer.

Optionally, the preparation method of a touch screen further includes: providing a cover glass on the connection layer.

Optionally, before providing a cover glass on the connection layer, it further includes: providing a polarizer on the cover glass, wherein

the polarizer is arranged on the connection layer.

The present invention has the following beneficial effects.

In the technical solution of a touch screen and a preparation method thereof provided by the present invention, the electrode layer includes a plurality of touch electrodes with spacing provided between the touch electrodes; and the filling structure is located in the spacing and has a preset refractive index, so that a refractive index of the electrode layer is equal to or approximate to that of the filling structure located in the spacing, the difference between the refractive index of the electrode layer and the refractive index of the filling structure is reduced, and the difference between the light transmittance of the electrode layer and the light transmittance of the filling structure is reduced, thereby avoiding poor vanishing phenomenon.

### BRIEF DESCRIPTION OF THE DRAWINGS

FIG. 1 is a structure diagram of a touch screen in the prior art;

FIG. 2 is a structure diagram of an exemplary touch screen provided by the present invention; and

FIG. 3 is a flowchart of a preparation method of a touch screen provided by the present invention.

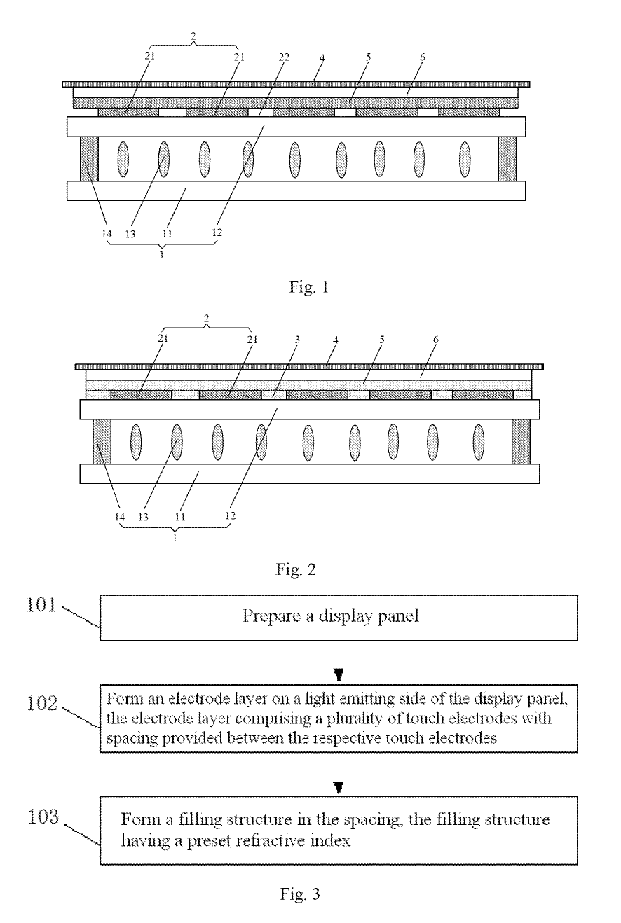

### DETAILED DESCRIPTION OF THE EMBODIMENTS

For a person of ordinary skill in the art to better understand the technical solution of the present invention, a touch screen and a preparation method thereof provided by the present invention will be described below in detail with reference to the accompanying drawings.

FIG. 2 is a structure diagram of a touch screen provided by the present invention. As shown in FIG. 2, the touch screen includes a display panel 1, an electrode layer 2, a filling structure 3 and a cover glass 4, the electrode layer 2 being located on a light emitting side of the display panel 1 and the electrode layer 2 including a plurality of touch electrodes 21 with spacing formed between the touch electrodes 21, the filling structure 3 being located in the spacing and the filling structure 3 having a preset refractive index, and the cover glass 4 being located on the electrode layer 2.

In the embodiment, the electrode layer 2 is a single-layer electrode layer, i.e., the plurality of touch electrodes 21 are manufactured by using the single-layer electrode layer and the plurality of touch electrodes 21 are arranged on a same layer. The touch electrodes 21 may include drive electrodes (Tx) and sensing electrodes (Rx), for example: the drive electrodes may be arranged transversally, and the sensing electrodes may be arranged longitudinally, wherein spacing being formed between the touch electrodes 21 may include spacing being formed between the drive electrodes and the sensing electrodes. Preferably, spacing may be formed between the drive electrodes, and spacing may also be formed between the sensing electrodes.

Further, the touch screen further includes a connection layer 5 which is located on the electrode layer 2, and the connection layer 5 may connect the cover glass 4 and the electrode layer 2 together, for example: the connection layer 5 may bond the cover glass 4 and the electrode layer 2. Preferably, the connection layer 5 and the filling structure 3 are integrally molded. FIG. 2 shows the situation of integrally molding in which the dotted line is plotted for clear representation of the structure of the connection layer 5 and the filling structure 3.

A ratio of the difference between the preset refractive index of the filling structure 3 and a refractive index of the electrode layer 2 to the refractive index of the electrode layer 2 is within a range of −20% to 20%, i.e., the ratio of the difference between the preset refractive index of the filling structure 3 and a refractive index of the electrode layer 2 to the refractive index of the electrode layer 2 is larger than or equal to −20% and less than or equal to +20%. When the ratio of the difference between the preset refractive index of the filling structure 3 and a refractive index of the electrode layer 2 to the refractive index of the electrode layer 2 is within a range of −20% to 20%, it indicates that a refractive index of the filling structure 3 is equal to or approximate to that of that of the electrode layer 2. For example, the preset refractive index may be larger than or equal to 1.2 and less than or equal to 1.8.

When the ratio of the difference between the preset refractive index of the filling structure 3 and a refractive index of the electrode layer 2 to the refractive index of the electrode layer 2 is within a range of −20% to 20%, a ratio of the difference between a preset light transmittance of the filling structure 3 and a light transmittance of the electrode layer 2 to the light transmittance of the electrode layer 2 is within a range of −5% to 5%, i.e., the ratio of the difference between a preset light transmittance of the filling structure 3 and a light transmittance of the electrode layer 2 to the light transmittance of the electrode layer 2, is larger than or equal to −5% and less than or equal to 5%, wherein the preset light transmittance of the filling structure 3 may be 95%. As a result, when the refractive index of the filling structure 3 is equal to or approximate to that of that of the electrode layer 2, the light transmittance of the filling structure 3 is equal to or approximate to that of that of the electrode layer 2, thereby enabling the light passing through the filling structure 3 and the electrode layer 2 to be basically consistent, and avoiding poor vanishing phenomenon.

Preferably, the filling structure 3 is made of apparent resin liquid glue, for example: the apparent resin liquid glue may be optically apparent resin (abbreviated as OCR) liquid glue. When the connection layer 5 and the filling structure 3 are integrally molded, the connection layer 5 and the filling structure 3 are made of the same material, i.e., the connection layer 5 may also be made of apparent resin liquid glue.

Further, the touch screen may also include a polarizer 6, and the polarizer 6 is located between the connection layer 5 and the cover glass 4. In this case, the connection layer 5 may connect the polarizer 6 and the electrode layer 2 together, for example: the connection layer 5 may bond the polarizer 6 and the electrode layer 2.

In the embodiment, the display panel 1 may be a liquid crystal display panel, the display panel 1 may include a first substrate 11 and a second substrate 12 which are arranged oppositely; a liquid crystal 13 is arranged between the first substrate 11 and the second substrate 12, and edges of the first substrate 11 and that of the second substrate 12 may be bonded by a sealant 14, wherein the first substrate 11 may be an array substrate, and the second substrate 12 may be a color film substrate; or the first substrate 11 may be a color filter on array substrate (color filter on array, abbreviated as COA), and the second substrate 12 may be a transparent substrate. In this case, a light incident side (under the first substrate 11 in FIG. 2) of the display panel 1 is also provided with the polarizer and a backlight module, and the polarizer and the backlight module are not shown specifically.

Optionally, the display panel 1 may also be an organic light-emitting diode (abbreviated as OLED) display panel, which is not drawn specifically.

In practical application, the filling structure 3 and the connection layer 5 may also be made of different materials, so the filling structure 3 and the connection layer 5 are not integrally molded structurally, and the filling structure 3 and the connection layer 5 are molded respectively during the preparation process. For example, the filling structure 3 is made of apparent resin liquid glue, and the connection layer 5 is made of PSA glue. This situation is not drawn specifically.

In the touch screen provided by the embodiment, the electrode layer includes a plurality of touch electrodes with spacing provided between the touch electrodes; and the filling structure is located in the spacing and has a preset refractive index, so that a refractive index of the electrode layer is equal to or approximate to that of the filling structure located in the spacing, the difference between the refractive index of the electrode layer and the refractive index of the filling structure is reduced, and the difference between the light transmittance of the electrode layer and the light transmittance of the filling structure is reduced, thereby avoiding poor vanishing phenomenon.

FIG. 3 is a flowchart of a preparation method of a touch screen provided by the present invention, as shown in FIG. 3, the method including the steps 101 to 103.

Step 101: A display panel is prepared.

Step 102: An electrode layer is formed on a light emitting side of the display panel, the electrode layer including a plurality of touch electrodes with spacing provided between the touch electrodes.

In the embodiment, an electrode material layer may be formed on the light emitting side of the display panel, and a patterning process is performed on the electrode material layer to form the electrode layer.

Step 103: A filling structure is formed in the spacing, the filling structure having a preset refractive index.

In the embodiment, the preparation method of a touch screen may further include: forming a connection layer located on the electrode layer, and the connection layer and the filling structure may be integrally molded. In this case, the step 103 specifically includes the sub-steps 1031 to 1032.

Sub-step 1031: A material layer is formed on the electrode layer, a part of the material layer being filled in the spacing to form the filling structure, wherein the material layer located on the electrode layer and the filling structure is formed as the connection layer.

In the embodiment, the material layer may be made of apparent resin liquid glue; because apparent resin liquid glue is capable of flowing, the material of a part of the material layer will flow to the spacing to fill the spacing. Accordingly, the material of the material layer is preferably a material capable of flowing.

In the embodiment, the preparation method of a touch screen may further include: providing a cover glass on the electrode layer. Further, before providing a cover glass on the electrode layer, the preparation method of a touch screen may further include: providing a polarizer on the cover glass, wherein the polarizer is arranged on the connection layer.

Sub-step 1032: The material layer (namely, the filling structure and the connection layer) is cured.

The cured connection layer may bond the electrode layer and the polarizer.

In the embodiment, description is given by merely taking the integral molding (synchronous molding) of the filling structure and the connection layer as an example, and the process is simple and easy to achieve. However, the filled structure and the connection layer may also be formed separately using the same or different materials, which is not specifically limited in the patent invention.

The preparation method of a touch screen provided by the embodiment may be used for preparing the touch screen provided by the aforementioned embodiment, and for the exemplary structure thereof reference may be made to description to the touch screen in the embodiment, which will not be repeated herein.

In the touch screen prepared by the preparation method of a touch screen provided by the embodiment, the electrode layer includes a plurality of touch electrodes with spacing provided between the touch electrodes; and the filling structure is located in the spacing and has a preset refractive index, so that a refractive index of the electrode layer is equal to or approximate to that of the filling structure located in the spacing, the difference between the refractive index of the electrode layer and the refractive index of the filling structure is reduced, and the difference between the light transmittance of the electrode layer and the light transmittance of the filling structure is reduced, thereby avoiding poor vanishing phenomenon.

It should be understood that the aforementioned implementations are merely exemplary implementations used for describing the principle of the present invention, and the present invention is not limited thereto. For a person of ordinary skill in the art, various variations and improvements may be made without departing from the spirit and essence of the present invention, and those variations and improvements should also be regarded as falling into the protection scope of the present invention.

1. A touch screen, comprising a display panel, an electrode layer, and a filling structure, the electrode layer being located on a light emitting side of the display panel and comprising a plurality of touch electrodes with spacing provided between the respective touch electrodes, and the filling structure being located in the spacing and having a preset refractive index.

2. The touch screen according to claim 1, further comprising a cover glass arranged on the electrode layer.

3. The touch screen according to claim 1, further comprising a connection layer located on the electrode layer.

4. The touch screen according to claim 3, wherein the connection layer and the filling structure are integrally molded.

5-15. (canceled)

16. The touch screen according to claim 1, wherein a ratio of the difference between the preset refractive index of the filling structure and a refractive index of the electrode layer to the refractive index of the electrode layer is within a range of −20% to 20%.

17. The touch screen according to claim 2, wherein a ratio of the difference between the preset refractive index of the filling structure and a refractive index of the electrode layer to the refractive index of the electrode layer is within a range of −20% to 20%.

18. The touch screen according to claim 3, wherein a ratio of the difference between the preset refractive index of the filling structure and a refractive index of the electrode layer to the refractive index of the electrode layer is within a range of −20% to 20%.

19. The touch screen according to claim 4, wherein a ratio of the difference between the preset refractive index of the filling structure and a refractive index of the electrode layer to the refractive index of the electrode layer is within a range of −20% to 20%.

20. The touch screen according to claim 16, wherein the preset refractive index of the filling structure is larger than or equal to 1.2 and less than or equal to 1.8.

21. The touch screen according to claim 16, wherein a ratio of the difference between a preset light transmittance of the filling structure and a light transmittance of the electrode layer to the light transmittance of the electrode layer is within a range of −5% to 5%.

22. The touch screen according to claim 1, wherein the filling structure is made of apparent resin liquid glue.

23. The touch screen according to claim 2, wherein the filling structure is made of apparent resin liquid glue.

24. The touch screen according to claim 3, wherein the filling structure is made of apparent resin liquid glue.

25. A preparation method of a touch screen, comprising:
preparing a display panel;
forming an electrode layer on a light emitting side of the display panel, the electrode layer comprising a plurality of touch electrodes with spacing provided between the respective touch electrodes; and
forming a filling structure in the spacing, the filling structure having a preset refractive index.

26. The preparation method of a touch screen according to claim 25, further comprising: forming a connection layer located on the electrode layer.

27. The preparation method of a touch screen according to claim 26, wherein the connection layer and the filling structure are integrally molded.

28. The preparation method of a touch screen according to claim 27, wherein the forming a filling structure in the spacing and forming a connection layer located on the electrode layer comprises:
forming a material layer on the electrode layer, a part of the material layer being filled in the spacing for forming the filling structure, and the material layer located on the electrode layer and the filling structure being used for forming the connection layer.

29. The preparation method of a touch screen according to claim 28, further comprising:
curing the material layer to form the filling structure and the connection layer.

30. The preparation method of a touch screen according to claim 26, further comprising: providing a cover glass on the connection layer.

31. The preparation method of a touch screen according to claim 30, further comprising, before providing a cover glass on the connection layer:
providing a polarizer on the cover glass, wherein the polarizer is arranged on the connection layer.
